(19) United States
(12) Patent Application Publication
(10) Pub. No.: US 2006/0147763 A1
(43) Pub. Date: Jul. 6, 2006

(54) Upflow microbial fuel cell (UMFC)

(76) Inventors: Largus Theodora Angenent, St. Louis, MO (US); Zhen He, St. Louis, MO (US)

Correspondence Address: THOMPSON COBURN, LLP, ONE US BANK PLAZA, SUITE 3500, ST LOUIS, MO, 63101, US

(21) Appl. No.: 11/323,441

(22) Filed: Dec. 30, 2005

Related U.S. Application Data
(60) Provisional application No. 60/640,702, filed on Dec. 30, 2004.

(51) Int. Cl. H01M 8/10; H01M 4/96; H01M 4/90; H01M 8/16

(52) U.S. Cl. 429/2; 429/30; 429/31; 429/44; 429/13; 429/43; 429/34

(57) ABSTRACT

An upflow microbial fuel cell in one embodiment is comprised of a generally cylindrical cathode chamber containing a cathode sitting atop a generally cylindrical anode chamber containing an anode, with a proton exchange membrane separating the two chambers, so that as influent is passed upwardly through the anode chamber electricity is created in a continuous process not requiring mixing such as with a mechanical mixer or the like. Electrodes are connected to each of the anode and the cathode for harvesting the electricity so created. Effluent may be recirculated through the anode chamber by a second inlet and outlet therein. A multiphase fuel cell includes a plurality of electrode couples arranged in a single chamber with an influent inlet near its bottom and an effluent outlet near its top, with the electrode couples connected in series to generate electricity at higher voltages. In another embodiment, the cathode chamber—preferably U-shaped—is positioned inside the anode chamber.

### CROSS-REFERENCE AND PRIORITY CLAIM TO RELATED APPLICATIONS

This application claims priority to provisional patent application 60/640,702 filed Dec. 30, 2004 and entitled “Upflow Microbial Fuel Cell (UMFC)”, the entire disclosure of which is incorporated herein by reference.

### BACKGROUND AND SUMMARY OF THE INVENTION

Building a sustainable society requires a reduction in the dependency on fossil fuels and a lowering of the amount of pollution generated. Wastewater treatment is an area in which these two goals can be addressed simultaneously. As a result there has been a recent paradigm shift from disposing of waste to using it. Many bioprocesses can provide bioenergy while simultaneously achieving the objective of pollution control. Industrial wastewaters from food-processing industries and breweries, and agricultural wastewaters from animal confinements are ideal candidates for bioprocessing, because they contain high levels of easily degradable organic material. The vast quantity of organics results in a net positive energy or economic balance even when heating of the liquid is required. In addition, they have a high water content, which circumvents the necessity to add water. Such wastewaters are potential commodities from which bioenergy may be produced. Recovery of energy may reduce the cost of wastewater treatment, and reduce our dependence on fossil fuels. Examples of bioprocessing strategies that can be used to treat industrial and agricultural wastewater with generation of bioenergy are: methanogenic anaerobic digestion to produce methane, hydrogen fermentation to produce hydrogen, and microbial fuel cells (“MFC's”) to produce bioelectricity. Methanogenic anaerobic digestion, hydrogen fermentation, and bioelectricity production share one property: the microbial community in the reactors is mixed and selection of the community is based on function. This is useful for the non-sterile, ever-changing, complex environment of wastewater treatment. In addition, the products from these bioprocesses can be easily separated as gases or bioelectricity.

Anaerobic digestion of industrial and agricultural wastewater to methane is a mature process utilized at full-scale facilities all over the world. The drawback of this technology is that during the conversion of methane to electricity, ˜70% of the energy content is lost in generators as heat. As a result, energy recovery from anaerobic digestion is mainly performed whenever there is a local need for energy, for example, to power drying processes at industrial operations. Hydrogen fermentation was developed as an alternative to methane generation. The mixed communities involved in hydrogen fermentation and methanogenic anaerobic digestion share some common elements with one important difference: successful biological hydrogen production requires inhibition of hydrogen-utilizing microorganisms. Unfortunately, hydrogen fermentation can, at best, utilize only ˜15% of the energy content of organic material present in wastes. Therefore, further development of hydrogen fermentation as a prominent treatment option seems unlikely. MFC's have since emerged as the most promising technology for energy production from wastewater.

Researchers in the prior art have successfully generated electricity biologically from wastewater (reaction 1 in Table 1). FIG. 1 shows a generic schematic of how a prior art MFC works. In principle, MFC's are similar to hydrogen fuel cells. Protons move from an anode compartment to a cathode compartment through an electrolyte membrane (i.e., electronically insulated proton-exchange membrane or PEM) with the electrons migrating via a conductive wire. A hydrogen fuel cell oxidizes hydrogen to electrons and protons on the anode and reduces oxygen to water on the cathode (reaction 2 in Table 1). Gas-permeable noble metals are used as electro-catalysts on the anode and cathode sides. In MFC's, on the other hand, anaerobic microorganisms oxidize organic material in the anode chamber and transfer the derived reducing equivalents (electrons) to the electrode rather than to an electron-acceptor molecule (reaction 1 in Table 1). As in hydrogen fuel cells, oxygen is reduced to water in the cathode of MFC's.

TABLE 1
Reactions for microbial and hydrogen fuel cells

| Biotic or | | |
|---|---|---|
| abiotic | | |
| process | Reaction | Number |
| MFC | C₆H₁₂O₆ + 6O₂ ⇄ 6CO₂ + 6H₂O + electricity | 1 |
| Hydrogen fuel | 2H₂ + O₂ ⇄ 2H₂O + electricity | 2 |
| cell | | |

To the inventors' knowledge, predominantly the work on MFCs has been conducted on batch-fed systems in a laboratory setting. Two notable exceptions are described in papers from researchers at PSU which do show continuously fed MFC's. However, their devices had a configuration that is not practical for wastewater treatment as their MFC was either more like a hydrogen fuel cell that usually has a small working volume or did not utilize fluid upflow, thereby requiring mechanical mixing. Yet another prior art device is described in an article entitled “Fuel-cell Microbes' Double Duty: Treat Water, Make Energy” in an NSF publication of Feb. 24, 2004. However that device is in a different configuration than the present invention, does not utilize upflow hydraulic flow, does not incorporate porous electrodes and further requires mechanical mixing. The device generates a power density of only 26 mW/m², which is considerably smaller than that generated by an embodiment of the present invention in prototype operation. Still another prior art device is described in an article entitled “Harnessing the Power of Poop” by Karen Miller, published at www.space.com on May 19, 2004. The fuel cell proposed in that article is intended for space travel and thus has design parameters uniquely related to its use, and certainly is not intended for large scale use for wastewater treatment. One example of these differences is the packed fiber used for the fuel cell are not well adapted for use in treating waste water as packed fibers would have a tendency to clog and block fluid flow. Instead, in the preferred design of the present invention, an electrode is used with large enough pores to minimize any blockage problems. These inherent limitations in the prior art design hinder the ability of such prior art designs to be scaled up for application to waste water treatment so that one of ordinary skill in the art would not find it obvious to adapt it for large scale use.

In order to solve these and other problems in the prior art, the inventors have developed a novel continuously-fed MFC that is particularly adapted to large scale use and is thus more practical for wastewater treatment: the upflow microbial fuel cell (UMFC). The UMFC was developed with the goal of combining the advantages of the upflow anaerobic sludge blanket (UASB) system, which is the most popular anaerobic bioreactor worldwide, with a dual-chamber MFC. The UASB system and its derivatives are advantageous, because they eliminate the need for mechanical mixers by creating an upflow hydraulic flow pattern in the reactor. Unlike the conventional dual-chamber MFC configuration (as shown in FIG. 1), the present invention locates the anode and cathode chambers on top of each other and separate them with a proton exchange membrane (Membrane International, Inc.; http://www.membranesinternational.com). In addition, commercially available carbon-fiber foam with a surface area of 0.5 cm²/cm³ (ERG Materials and Aerospace Corporation; http://www.ergaerospace.com) is used in the reactor to increase the anode electrode surface. As a result, the anode chamber in the UMFC is operated as an anaerobic filter, with a biofilm on the carbon-fiber foam, and an upflow hydraulic pattern to promote mixing without use of a mechanical mixer. Wastewater influent is continuously fed at the bottom of anode chamber while effluent is discharged from the top of same chamber, thereby establishing a continuous fluid flow through the UMFC. Microorganisms in the anode chamber degrade organic pollutants, produce protons and transfer electrons via an external circuit. Protons pass through the proton exchange membrane into a cathode chamber, where oxygen takes electrons and protons to produce water. In this manner, electricity is continuously produced in greater power density than previously possible with the prior art designs.

A prototype of the invention has been operated and has produced a maximum power density of up to 170 mW/m² of electrode surface (total electrode surface area is 97 cm²). With this prototype, a power density of 170 mW/M² of electrode surface translates to around 3.1 W/m³ of wet anode volume. The inventors believe that the power density will be increased considerably over time with continued selection pressure on the microbial community and an increase in the loading rate (the prototype is currently operating the UMFC at a chemical oxygen demand [COD] loading rate of 1.2 g COD/liter/day and achieves a COD removal efficiency exceeding 90%). Also, the inventors have determined the polarization curve of the prior art MFC, shown in FIG. 2, and found the optimum resistance to be 50-150Ω.

The inventors believe that further development will help to maximize the power density of the UMFC at higher volumetric loading rates, such as would be helpful in adapting the present invention to commercial use. Also, the reactor configuration and operating conditions are amenable to further optimization. Although further development would be helpful in building a commercial design, it is believed that the present invention is complete and proves that it is useful for its intended and claimed application.

As an example of such further development, the inventors herein disclose a modified UMFC design wherein a generally cylindrical and U-shaped cathode chamber is positioned inside the anode chamber. Furthermore, granular articulated carbon can be used as the electrode material. Testing by the inventors has indicated that such a design can greatly improve the UMFC's power output.

Furthermore, the inventors disclose a multi-phase UMFC which incorporates some of the changes considered to build a commercial device.

While a brief explanation of the invention has been provided above, a fuller understanding of the invention may be gained by referring to the drawings and description of the preferred embodiment which follows.

### BRIEF DESCRIPTION OF THE DRAWINGS

FIG. 1 is a schematic of a prior art dual-chamber MFC;

FIG. 2 depicts a polarization curve for the MFC of FIG. 1;

FIG. 3 is a schematic of the UMFC of an embodiment of the present invention;

FIG. 4 is a photographic rendition of the prototype built and operated demonstrating the operability of the present invention;

FIG. 5 is a graph illustrating the COD removal efficiency in operation of the prototype;

FIG. 6 is a graph illustrating the power density achieved by the prototype under different loading;

FIG. 7 is a photographic rendition of biomass in the prototype illustrating the microbes (archaea and bacteria) growing as a biofilm on the carbon-fiber electrode of the anode;

FIG. 8 is a schematic diagram of a multiphase design for commercialization of the present invention;

FIG. 9 is a schematic of another UMFC embodiment of the present invention; and

FIG. 10 is a graph that charts power output as a function of loading rate for the embodiment of FIG. 9.

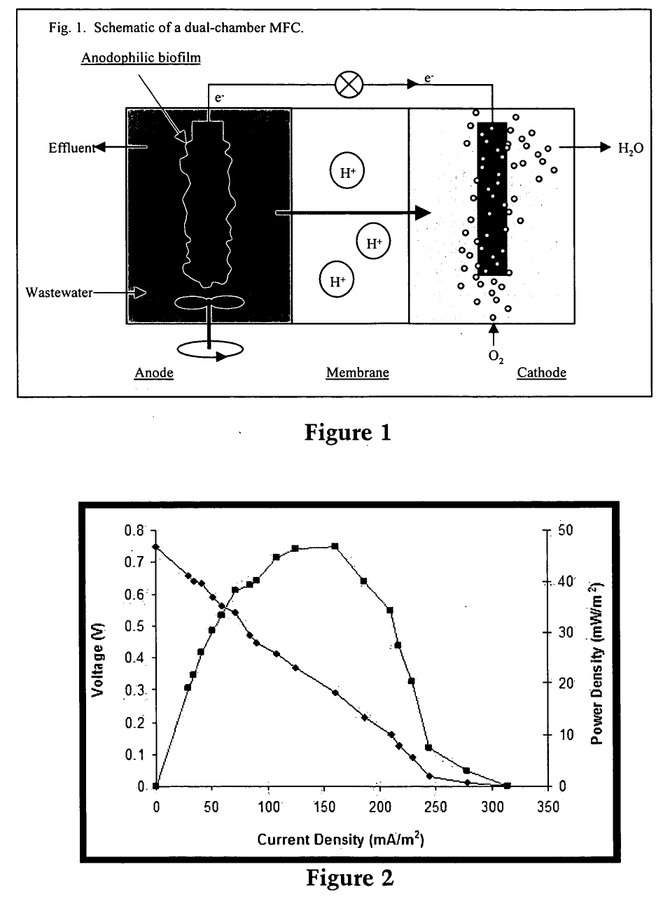

### DETAILED DESCRIPTION OF THE PREFERRED EMBODIMENT

For ease and clarity in explanation, the prototype dimensions and performance will be described as an embodiment of the present invention. One of ordinary skill in the art will understand that the prototype would undoubtedly be further developed and changed, using the teaching provided herein, in order to provide a design for commercial application. Nevertheless, the prototype functions, as described herein, and proves that the invention will work for the purposes intended.

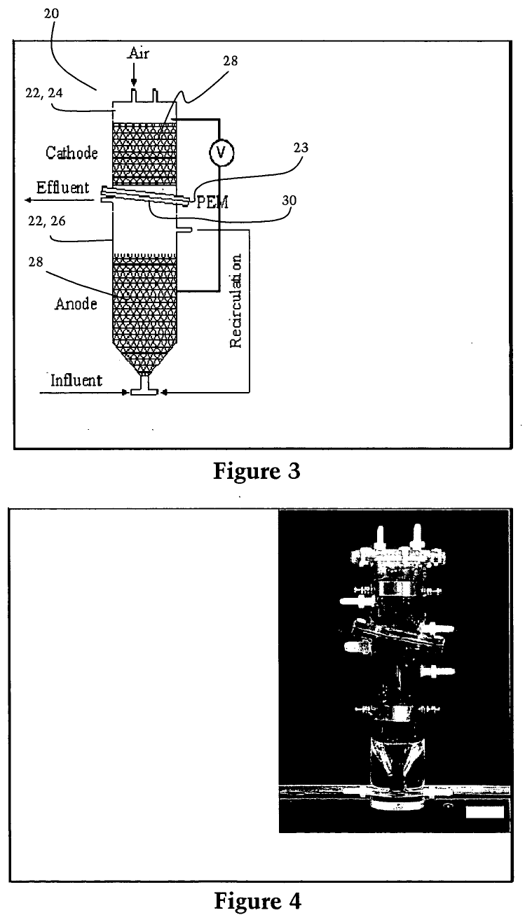

As shown in FIGS. 3 and 4, the invention of an UMFC 20 is generally comprised of two cylindrical preferably Plexiglas chambers 22 with substantially the same diameter which in the working prototype is 6 cm. A Plexiglas flange 23 joins the two chambers 22 and is arranged at an angle to horizontal, as explained below. The upper chamber 24 is a cathode chamber and the lower chamber 26 is an anode chamber. The cathode chamber 24, which is preferably 9 cm in height, is arranged vertically on top of the anode chamber 26, which is preferably 15 cm in height, and has a volume with electrode of 440 cm³, including the cone at the bottom. Both chambers contain reticulated vitreous carbon (RVC, ERG, Oakland, Calif.) as electrodes 28. PPIs (pores per linear inch) of the anode and the cathode electrodes are 10 and 20 respectively. The anode electrode has a total volume of 190 cm³ and surface area of 97 cm², while the cathode electrode is 170 cm³ in volume. A proton exchange membrane (PEM) 30 (PEM, Ultrex, Membrane International Inc., Glen Rock, N.J.) is installed between the two chambers 24, 26 at the flange 23 with an angle of preferably 15 degrees to horizontal plane. This angle is considered non-critical except as necessary to prevent biogas bubbles generated during organic degradation from accumulating on the PEM. Electrodes 28 are connected by copper wires to complete an electrical circuit.

The UMFC prototype was operated at 35° C. and continuously fed with a synthetic wastewater at a loading rate of 1.2 g COD/liter/day during a start-up period. The cathode chamber was filled with 100 mM potassium hexacyanoferrate (i.e., ferricyanide) to improve the electron transfer from electrode to oxygen. Biogas production was measured by a wet gas meter (Actaris Meterfabriek BV, The Netherlands).

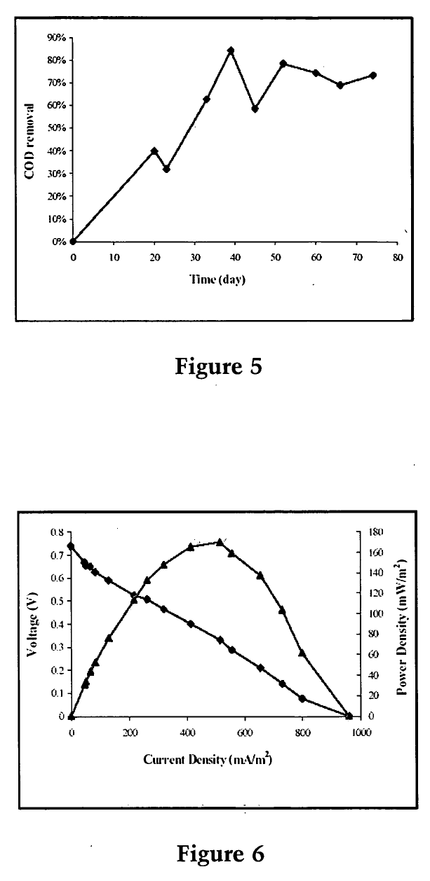

The efficiency of the organic removal and the influence of limitation factors on the power output were examined. A synthetic wastewater containing sucrose was continuously fed into the bottom of the UMFC with a hydraulic retention time (HRT) of approximately 10 hours and the effluent was discharged from the top of the anode chamber. Biomass was maintained by the electrode (RVC) and the flow rate. The UMFC was able to continuously generate electricity with simultaneous chemical oxygen demand (COD) removal. The efficiency of COD removal was greater than 80% at a loading rate of 1.2 g COD/liter/day (see FIG. 5). The open voltage potential reached 0.79 V after 60 hours' operation at a flow rate of 0.36 ml/min. When the open potential was constant, an external resistor was connected between the anode and the cathode electrodes to generate current. The power output varied under different loading (resistance from 10 to 1470 W) (see FIG. 6). The polarization curve showed that the maximum power density of 170 mW/m² occurred at 66Ω (0.33V). The short circuit current was 9.31 mA.

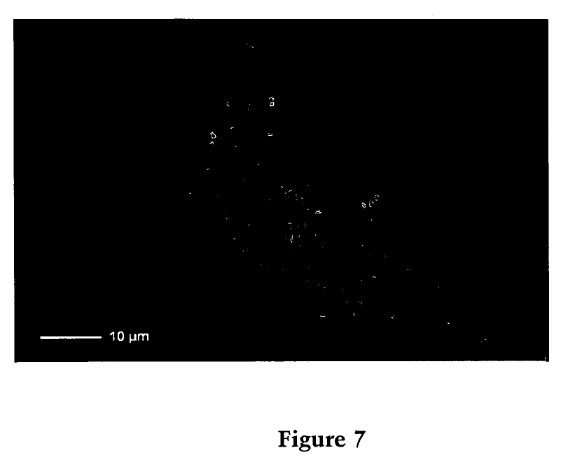

The UMFC has several advantages over prior art MFC's, including the following. First, no mechanical mixing is required because of the supernatant solution agitation. Most current MFC's do not use mixing or use mixing through mechanical stirring for mixing. These approaches are not practical when MFC's are scaled up. Stirring or mechanical mixing requires the input of extra energy and restricts the possible configuration of MFC's. Second, the upflow fluid flow solution provided in the UMFC assists proton transport and biomass maintenance (see FIG. 7 which is a microscopy view that depicts a thick biomass). Finally, the UMFC is operated in a continuous flow mode instead of a batch-fed mode, which is more practical for further scale-up as a continuous flow eliminates a host of problems indigenous to batch processing, such as down time required before feeding, the need for a wastewater holding tank, and the non-continuous electricity production.

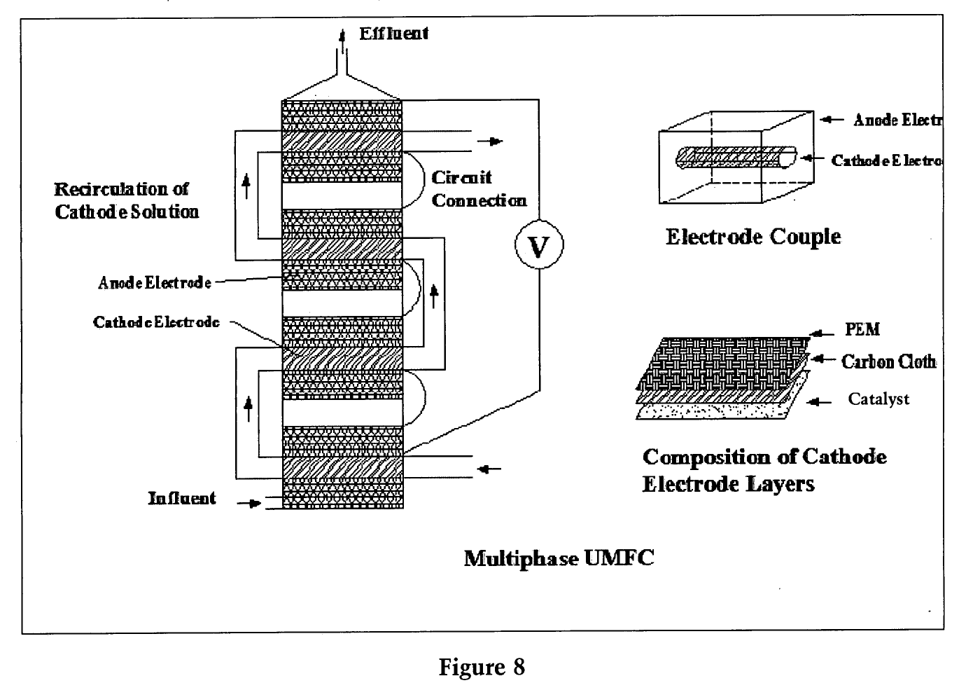

The prototype has been described above. Additionally the inventors contemplate another embodiment, a multi-phase embodiment. The prior art MFC's consist of one couple of electrodes, which can generate a maximum open potential of 0.79 V. Even with the maximum open potential, those MFC's are not feasible for power generation in wastewater treatment plants as most AC voltage is generated at much higher voltages for first transmission and then for step down to 110 volts for operation at the consumer level. For commercial applicability, a device is required that can produce high voltage and treat wastewater at the same time. The inventors offer a first solution to the commercialization issues with a multiphase UMFC, which utilizes the main idea of the UMFC, with an ‘upflow’ hydraulic flow pattern. The multiphase UMFC is composed of several electrode couples connected in series (see FIG. 8), and through which influent is circulated. As shown in FIG. 8, each electrode couple is comprised of a rectangular piece of RVC as an anode and a piece of carbon cloth as a cathode. PEM is pressed by heat on one side of the carbon cloth and a catalyst is pressed on the other side. Then the carbon cloth is rolled up and inserted into the RVC. Numerous of these electrode couples are then inserted in a chamber and the effluent passed therethrough for reaction therewith. This arrangement circumvents problems potentially caused by any proton movement limitation during scale up to larger reactor volumes, because anode and cathode electrodes remain always in close proximity to each other.

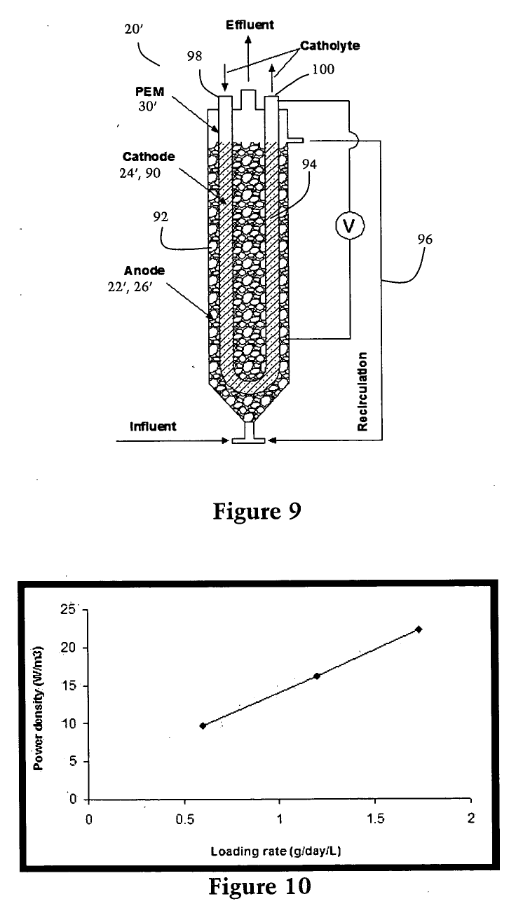

FIG. 9 depicts yet another embodiment of the present invention. With this embodiment, the UMFC 20′ comprises a cylindrical chamber 22′ with a conical end that serves as the anodic chamber 26′, as generally described in connection with FIG. 3. The cathode chamber 24′ of the FIG. 9 embodiment comprises a generally cylindrical U-shaped chamber 90, wherein the cathode chamber 24′ is positioned inside the anode chamber 26′. The cathode chamber 90 preferably has a total volume of 210 cm³. The anode chamber 26′ preferably has a total volume of 480 cm³, of which 180 cm³ is available for liquid volume following insertion of the cathode chamber 90′ and electrode material into the anode chamber, as explained below. The total height of the UMFC embodiment of FIG. 9 is preferably 35 cm. However, it should be noted that other dimensions could be used in the practice of the invention.

It is also worth noting that the shape of the cathode chamber 24′ need not be U-shaped. While the U-shape provides some advantages with respect to recirculation, the cathode chamber 24′ need only be positioned inside the anode chamber 24′ with this embodiment. For example, the cathode chamber 24′ can also be a straight cylindrical tube as shown in FIG. 8.

The PEM 30′ is positioned to serve as an interface between the content of the anode chamber 26′ and the cathode chamber 90. The PEM 30′ is preferably formed by rolling up a flat sheet of PEM material and attaching the two sides together (by gluing, welding, or the like) to effectively create a tube. This tube can then be shaped as a U and positioned inside the anode chamber. The inner volume of the tube can then serve as the cathode chamber 90.

While the electrodes 92 and 94 can be made of any of a wide range of electrode materials, the inventors prefer that granular activated carbon be used as the electrode material, as explained below. Granular activated carbon is commercially available—for example from the General Carbon Corporation of Paterson, N.J. Preferably, the U-shaped cathode chamber 90 that is defined by the inner volume of the PEM tube is first positioned within the anode chamber 26′ and a remainder of the volume within the anode chamber is filled with the electrode granules, leaving approximately 180 cm³ of volume within the anode chamber for wastewater. During use, wastewater will upwardly flow through the gaps between the granules. Recirculation path 96 can be used to return wastewater to the anode chamber's inlet. A graphite rod within the anode chamber (not shown) can serve as the contact with the granular activated carbon anodic electrode 92 through which the electrons flow. The graphite rod can be positioned anywhere within the anode chamber so long as it contacts some of the carbon granules. For example, the graphite rod can be positioned to extend into a side wall of the anode chamber by drilling a hole in a sidewall of the anode chamber and inserted the graphite rod through the drilled hole.

Granular activated carbon is also added into the cathode chamber 90 to serve as the cathodic electrode. A conductive carbon fiber inside the cathode chamber (not shown) can serve as the contact for the cathode electrode 94. This carbon fiber can be inserted in one end of the cathode chamber and positioned such it comes out at both ends of the cathode chamber (see inlet 98 and outlet 100 of the cathode chamber 90). One of these carbon fiber ends can then be connected with an external circuit, wherein the external circuit is also connected to the end of the graphite rod that extends out from the anode chamber's sidewall. An electron mediator such as ferricyanide is preferably recirculated through the cathode tube through inlet 98 and outlet 100 via a pump (not shown) or the like.

With the configuration of FIG. 9, the inner volume of the anode electrode can be more greatly utilized and the space between electrodes can be reduced. Experimentation by the inventors with this embodiment has produced a power output of 25 W/m³ of wet anode volume. In addition to this higher power output, the inventors have observed markedly improved coulombic efficiency (i.e., the percentage of available electrons in sugar that are transferred to the anodic electrode and measured as power) that reaches 33.6% at a loading rate of 1.2 g/L/day. This power output was observed to be even higher at a lower loading rate (50.2% at 0.6 g/L/day). This increase in coulombic efficiency demonstrates that electrons produced from biodegradation of organic compounds were harvested as electricity rather than ending up as methane. Also, the capabilities of UMFC 20′ to remove organic pollutants from wastewater remain excellent. The soluble COD of the inventive system described in connection with FIG. 9 was maintained at ˜30 mg/L with an influent concentration of 275 mg/L (thus, the removal efficiency was ˜88%), thereby indicating that the UMFC is a highly efficient reactor for wastewater treatment.

Also, low HRT allows a UMFC to be constructed with smaller reactor volumes for a given power output, thereby decreasing the capital costs for the UMFC. With the configuration shown in FIG. 9, the HRT for the UMFC can be reduced to 6 hours.

The foregoing description of inventive embodiments is being made to provide a non-limiting disclosure of the invention, and is thereby intended for illustrative purposes only. There are changes and variations to the invention which would become apparent to one of ordinary skill in the art, using the teaching of the inventors as disclosed herein. For example, the inventors herein have found that the use of a platinum-coated cathode electrode with the UMFC 20 of FIG. 3 instead of placing the cathode electrode in a solution of an electron mediator (preferably ferricyanide) can improve the UMFC's power output. Experimentation has shown the inventors that a power output of 5.1 W/m³ of wet anode volume can be achieved through the use of platinum-coated electrodes. Further still, the electrode material that is chosen in the practice of the present invention can vary. The inventors herein disclose that the electrode material should be highly conductive, strong, have a high surface area, have a sufficient surface property for attachment of bacteria, and exhibit a sufficiently low cost (particularly for wastewater treatment processes). Based on these factors, persons having ordinary skill in the art can select the electrode material that is appropriate for a given application of the present invention. While the FIG. 3 prototype described herein utilized porous RVC as the electrode material, it should be noted that other specific examples of electrode materials that can be used include but are not limited to carbon paper, woven carbon-fiber cloth, granular activated carbon, and woven activated-carbon cloth. Following experimentation with these electrode materials, the inventors herein found that granular activated carbon is preferred (as described in connection with FIG. 9). Furthermore, while experimentation with the UMFC design 20′ of FIG. 9 has produced a power output of 25 W/m³ of wet anode volume, the inventors herein believe that extrapolation from the graph of FIG. 10 indicates that further increases in power output can be produced by increasing the volumetric loading rates.

Such changes and variations are to be considered as part of the invention, which should be considered only as limited by the claims as appended, and their legal equivalents.

What is claimed is:

1. A microbial fuel cell comprising:
an anode chamber having an inlet through which influent enters the anode chamber and an outlet through which effluent exits the anode chamber, wherein the anode chamber is arranged for a continuous general upflow of influent from the inlet through the outlet;
a cathode chamber; and
an electrolyte membrane that interfaces the anode chamber with the cathode chamber such that a flow of protons from the anode chamber to the cathode chamber occurs when the influent comprises water and degradable organic material; and
wherein the anode chamber and the cathode chamber are in electrical communication with each other to produce a voltage potential when the influent comprises water and degradable organic material.

2. The microbial fuel cell of claim 1 wherein the cathode chamber is positioned inside the anode chamber.

3. The microbial fuel cell of claim 2 wherein the electrolyte membrane is adapted and configured to form a tube, the tube having an inner volume, the tube's inner volume defining the cathode chamber.

4. The microbial fuel cell of claim 3 wherein the electrolyte membrane tube comprises a generally U-shaped tube, thereby resulting in the cathode chamber having a generally U-shape.

5. The microbial fuel cell of claim 4 further comprising an electrode material within the anode chamber and an electrode material within the cathode chamber.

6. The microbial fuel cell of claim 5 wherein the electrode material comprises granular activated carbon.

7. The microbial fuel cell of claim 6 wherein the electrolyte membrane comprises a proton exchange membrane.

8. The microbial fuel cell of claim 5 further comprising an external electrical circuit connected between the cathode chamber electrode material and the anode chamber electrode material.

9. The microbial fuel cell of claim 3 wherein the cathode chamber comprises a generally cylindrical cathode chamber.

10. The microbial fuel cell of claim 1 wherein the cathode chamber is arranged vertically atop the anode chamber.

11. A bioenergy production method, the method comprising:
continuously feeding an influent into an upflow microbial fuel cell, the fuel cell comprising an anode chamber, a cathode chamber, and a proton exchange membrane that interfaces the anode chamber with the cathode chamber, wherein the anode chamber is arranged for an upflow of the influent, the influent comprising water and degradable organic material, wherein the cathode chamber and the anode chamber are in electrical communication with each other;
within the anode chamber, oxidizing the influent's organic material with anaerobic microogranisms, thereby producing a plurality of electrons; and
producing a voltage potential between an electrode of the anode chamber and an electrode of the cathode chamber.

12. The method of claim 11 further comprising:
connecting a load to the produced voltage potential.

13. The method of claim 12 wherein the cathode chamber is positioned inside the anode chamber.

14. The method of claim 13 wherein the cathode chamber comprises a generally cylindrical U-shaped cathode chamber.

15. The method of claim 14 wherein the anode chamber electrode and the cathode chamber electrode comprise granular activated carbon.

16. The method of claim 11 wherein the cathode chamber is arranged vertically atop the anode chamber.

17. A microbial fuel cell comprising a first chamber containing an anode and a second chamber containing a cathode, said anode chamber having an inlet through which influent may be passed to enter the anode chamber, said anode chamber having an outlet near its top and through which effluent may be passed to exit the anode chamber, said chambers being in fluid communication and arranged to provide a generally upward flow of fluid therethrough.

18. The microbial fuel cell of claim 17 further comprising a proton exchange membrane joining said chambers, said proton exchange membrane being oriented at approximately 15 degrees from horizontal.

19. The microbial fuel cell of claim 18 wherein said anode and said cathode are comprised-of reticulated vitreous carbon.

20. The microbial fuel cell of claim 19 further comprising a second outlet in said anode chamber through which effluent may be passed back to the inlet for recirculation through the anode chamber.

21. The microbial fuel cell of claim 18 wherein said anode and said cathode are comprised of carbon paper.

22. The microbial fuel cell of claim 18 wherein said anode and said cathode are comprised of woven carbon-fiber cloth.

23. The microbial fuel cell of claim 18 wherein said anode and said cathode are comprised of granular activated carbon.

24. The microbial fuel cell of claim 18 wherein said anode and said cathode are comprised of woven activated-carbon cloth.

25. The microbial fuel cell of claim 17 wherein said anode chamber and said cathode chamber are vertically connected to each other.

26. The microbial fuel cell of claim 25 wherein said chambers are of substantially the same width.

27. The microbial fuel cell of claim 26 wherein each of said chambers are cylindrically shaped and of approximately the same diameter.

28. The microbial fuel cell of claim 17 wherein said cathode chamber is positioned inside the anode chamber.

29. The microbial fuel cell of claim 28 wherein the cathode chamber comprises a generally cylindrical and U-shaped cathode chamber.

30. A microbial fuel cell comprising a first chamber containing an anode and a second chamber containing a cathode, said anode chamber having an inlet through which influent may be passed to enter the anode chamber, said anode chamber having an outlet near its top and through which effluent may be passed to exit the anode chamber, said cathode chamber being in fluid communication and arranged vertically to said anode chamber with a generally porous proton exchange membrane separating the two chambers to thereby provide a generally upward and continuous flow of fluid therethrough.

31. The microbial fuel cell of claim 30 wherein said chambers are both generally cylindrical in shape and of substantially the same size, and further comprising a flange joining said chambers, said proton exchange membrane being located substantially at said flange.

32. The microbial fuel cell of claim 31 wherein said proton exchange membrane is arranged at approximately 15 degrees to horizontal.

33. The microbial fuel cell of claim 32 further comprising an extra outlet and inlet in fluid communication with the anode chamber for recirculation of effluent through said anode chamber.

34. The microbial fuel cell of claim 30 further comprising an electrode connected to each of said anode and said cathode.

35. The microbial fuel cell of claim 34 wherein said cathode-connected electrode comprises a platinum-coated cathode-connected electrode.

36. A method for generating electricity in a microbial fuel cell comprising:
providing an anode in a first chamber and a cathode in a second chamber, said chambers being arranged with the second chamber being vertically higher than the first chamber,
providing an electrode attached to each of said anode and said cathode,
creating a continuous flow of influent through the first chamber, and
harvesting the electricity created by said fuel cell at the electrodes.

37. The method of claim 36 further comprising recirculating effluent through the anode chamber.

38. The method of claim 37 wherein said chambers are in fluid communication with each other and further comprising separating said chambers with a proton exchange membrane.

39. A multiphase microbial fuel cell comprising a single chamber, said chamber having an influent inlet near its bottom and an effluent outlet near its top, and a plurality of electrode couples arranged in said chamber so that as influent passes through said chamber it flows through said electrode couples.

40. The multiphase microbial fuel cell of claim 39 wherein said electrode couples each have an anode and a cathode, said cathode being contained within its associated anode.

41. The multiphase microbial fuel cell of claim 40 wherein each of said anodes comprise a rectangular piece of RVC.

42. The multiphase microbial fuel cell of claim 41 wherein each of said cathodes comprise a piece of carbon cloth.

43. The multiphase microbial fuel cell of claim 42 wherein said electrode couples are connected in series.
